(19) United States
(12) Patent Application Publication
(10) Pub. No.: US 2022/0262317 A1
(43) Pub. Date: Aug. 18, 2022

(54) DISPLAY DRIVING CIRCUIT, DISPLAY APPARATUS INCLUDING THE SAME, AND OPERATING METHOD OF THE DISPLAY DRIVING CIRCUIT

(71) Applicant: Samsung Electronics Co., Ltd., Suwon-si (KR)

(72) Inventors: Tao-Jung HUNG, Hsinchu County (TW); Chao Hsuan LIU, Hsinchu County (TW); Chulho CHOI, Seoul (KR); Hajoon SHIN, Hwaseong-si (KR); Chui-Hsun CHIU, Hsinchu City (TW); Myungho SEO, Hsinchu County (TW); Yu-Wen CHIOU, Suwon-si (KR)

(73) Assignee: Samsung Electronics Co., Ltd., Suwon-si (KR)

(21) Appl. No.: 17/668,018

(22) Filed: Feb. 9, 2022

(30) Foreign Application Priority Data
Feb. 18, 2021 (KR) 10-2021-0022031

(51) Int. Cl. G09G 3/3275

(52) U.S. Cl. CPC G09G 3/3275; G09G 2310/0243; G09G 2310/027; G09G 2300/0814; G09G 2310/0291

(57) ABSTRACT

A display driving circuit including a reference voltage generator configured to generate a plurality of reference voltages, a buffer circuit configured to generate an output voltage based on a reference voltage, from among the reference voltages, applied to an input node thereof, and a precharging circuit configured to precharge the input node based on a first control signal in a transition period, which is a time period between a first point in time at which a first reference voltage is applied to the input node and a second point in time at which a second reference voltage is applied to the input node, may be provided.

### CROSS-REFERENCE TO RELATED APPLICATION

This application is based on and claims priority under 35 U.S.C. § 119 to Korean Patent Application No. 10-2021-0022031, filed on Feb. 18, 2021, in the Korean Intellectual Property Office, the disclosure of which is incorporated by reference herein in its entirety.

### BACKGROUND

The inventive concepts relate to semiconductor devices, and more particularly, to display driving circuits, display apparatuses including the same, and/or an operating methods of the display driving circuit, in which crosstalk is reduced when adaptive fast voltage tracking (AFVT) is applied to the display apparatus.

Display apparatuses are being widely used in smartphones, notebook computers, and monitors and include a display panel which displays an image. A plurality of pixels are provided in the display panel. As the plurality of pixels are driven by a data signal supplied from a display driver integrated circuit (IC), the display panel implements an image.

As display apparatuses enlarge in screen size, resolution increases, and thus, when a reference voltage generator supplies a reference voltage to the display panel through a buffer circuit, defective image quality such as crosstalk may occur. An electrical interference phenomenon, where undesired pixels are adversely affected by driving of an adjacent pixel in the display panel, is referred to as crosstalk.

### SUMMARY

The inventive concepts provide display driving circuits, display apparatuses including the same, and/or operating methods of the display driving circuit, which decrease noise such as crosstalk by using a push-pull circuit and a voltage selection circuit for precharging a reference voltage in a process of supplying the reference voltage to a display panel.

According to an aspect of the inventive concepts, a display driving circuit may include a reference voltage generator configured to generate a plurality of reference voltages, a buffer circuit configured to generate an output voltage based on a reference voltage, from among the reference voltages, applied to an input node thereof, and a precharging circuit configured to precharge the input node based on a first control signal in a transition period, the transition period being a time period between a first point in time at which a first reference voltage is applied to the input node and a second point in time at which a second reference voltage is applied to the input node.

According to another aspect of the inventive concepts, an operating method of a display driving circuit may include generating a first control signal for precharging an input node in a transition period, the transition period being a time period between a first point in time at which a first reference voltage is applied to the input node and a second point in time at which a second reference voltage is applied to the input node, precharging the input node based on the first control signal, applying the second reference voltage to the input node, and generating an output voltage based on the second reference voltage.

According to still another aspect of the inventive concepts, a display apparatus may include a display panel and a display driving circuit configured to drive the display panel so that the display panel displays an image. The display driving circuit may include a reference voltage generator configured to generate a plurality of reference voltages, a buffer circuit configured to generate an output voltage from a reference voltage, from among the reference voltages, applied to an input node thereof, a precharging circuit configured to precharge the input node based on a first control signal, and a controller configured to generate the first control signal for precharging the input node in a transition period, the transition period being a time period between a first point in time at which a first reference voltage is applied to the input node and a second point in time at which a second reference voltage is applied to the input node.

### BRIEF DESCRIPTION OF THE DRAWINGS

Some example embodiments of the inventive concepts will be more clearly understood from the following detailed description taken in conjunction with the accompanying drawings in which:

FIG. 1 is a block diagram illustrating a display apparatus and a display system including the display apparatus, according to an example embodiment;

FIG. 2 is a block diagram illustrating a display driving circuit and a display panel, according to an example embodiment;

FIG. 3 is a block diagram schematically illustrating a display driving circuit according to an example embodiment;

FIG. 4 is a block diagram schematically illustrating a voltage tracking circuit according to an example embodiment;

FIG. 5 is a circuit diagram illustrating a reference voltage generator according to an example embodiment;

FIG. 6 is a block diagram schematically illustrating a voltage tracking circuit according to an example embodiment;

FIG. 7A is a circuit diagram illustrating a voltage tracking circuit according to an example embodiment, and FIG. 7B is a graph for describing an operation signal of FIG. 7A;

FIG. 8A is a circuit diagram illustrating a reference voltage generator and a buffer circuit according to an example embodiment, and FIG. 8B is a graph for describing an operation signal of FIG. 8A;

FIG. 9 is a circuit diagram illustrating a voltage selection circuit according to an example embodiment;

FIG. 10 is a flowchart illustrating an operating method of a display driving circuit according to an example embodiment;

FIG. 11 illustrates an implementation example of a display apparatus according to an example embodiment; and

FIG. 12 illustrates an implementation example of a display apparatus according to an example embodiment.

### DETAILED DESCRIPTION

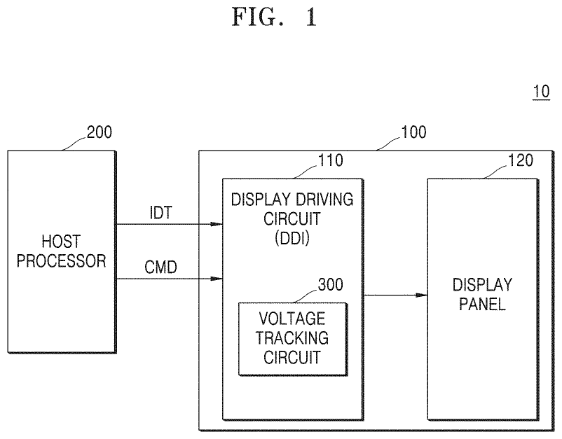

FIG. 1 is a block diagram illustrating a display apparatus and a display system 10 including the display apparatus, according to an example embodiment.

The display system 10 according to an example embodiment may be equipped in an electronic device having an image display function. For example, the electronic device may include smartphones, tablet personal computers (PCs), portable multimedia players (PMPs), cameras, wearable devices, televisions (TVs), digital video disk (DVD) players, refrigerators, air conditioners, set-top boxes, robots, drones, various medical devices, navigation devices, global positioning system (GPS) receivers, vehicle devices, furniture, and various measuring instruments.

Referring to FIG. 1, the display system 10 may include a display apparatus 100 and a host processor 200, and the display apparatus 100 may include a display driving circuit 110 (or referred to as a display driving integrated circuit (IC)) and a display panel 120.

The host processor 200 may generate image data IDT, which is to be displayed by the display panel 120, and may transfer the image data IDT and a control command CMD to the display driving circuit 110. For example, the control command CMD may include setting information about, for example, luminance, gamma, a frame, a frequency, and/or an operation mode of the display driving circuit 110. Although not shown, the host processor 200 may transfer a clock signal or a synchronization signal to the display driving circuit 110.

The host processor 200 may include a graphics processor. However, the inventive concepts are not limited thereto, and the host processor 200 may be implemented as various kinds of processors such as a central processing unit (CPU), a microprocessor, a multimedia processor, and an application processor. In an example embodiment, the host processor 200 may be implemented with an IC or a system on chip (SoC).

The display apparatus 100 may display the image data IDT received from the host processor 200. In an example embodiment, the display apparatus 100 may be an apparatus where the display driving circuit 110 and the display panel 120 are implemented as one module. For example, the display driving circuit 110 may be mounted on a substrate of the display panel 120, or the display driving circuit 110 may be electrically connected to the display panel 120 through a connection member such as a flexible printed circuit board (FPCB).

The display panel 120 may be a display unit which displays a real image, and may include one of display apparatuses, which receive an electrically transferred image signal to display a two-dimensional (2D) image, such as organic light emitting diode (OLED) displays, thin film transistor-liquid crystal displays (TFT-LCDs), filed emission displays, and plasma display panels (PDPs). Hereinafter, in the inventive concepts, it may be assumed that the display panel 120 is an OLED display panel where each of a plurality of pixels includes an OLED. However, the inventive concepts are not limited thereto, and the display panel 120 may be implemented as a different kind of flat display panel or flexible display panel.

The display driving circuit 110 may convert the image data IDT, received from the host processor 200, into a plurality of analog signals (for example, a plurality of data voltages) for driving the display panel 120 and may supply the plurality of analog signals to the display panel 120. Therefore, the display panel 120 may display an image corresponding to the image data IDT.

The display driving circuit 110 according to an example embodiment may include a voltage tracking circuit 300. The voltage tracking circuit 300 may precharge a reference voltage in a transition period where the reference voltage supplied to the display panel 120 varies, by using a push-pull circuit and a voltage selection circuit, and thus may remove noise including crosstalk occurring in display driving. In an example embodiment, in the transition period before a second reference voltage is applied to an input node to which a first reference voltage has been applied, the voltage tracking circuit 300 may generate a first control signal for precharging the input node, precharge the input node on the basis of the first control signal, apply the second reference voltage to the input node, and generate an output voltage on the basis of the second reference voltage.

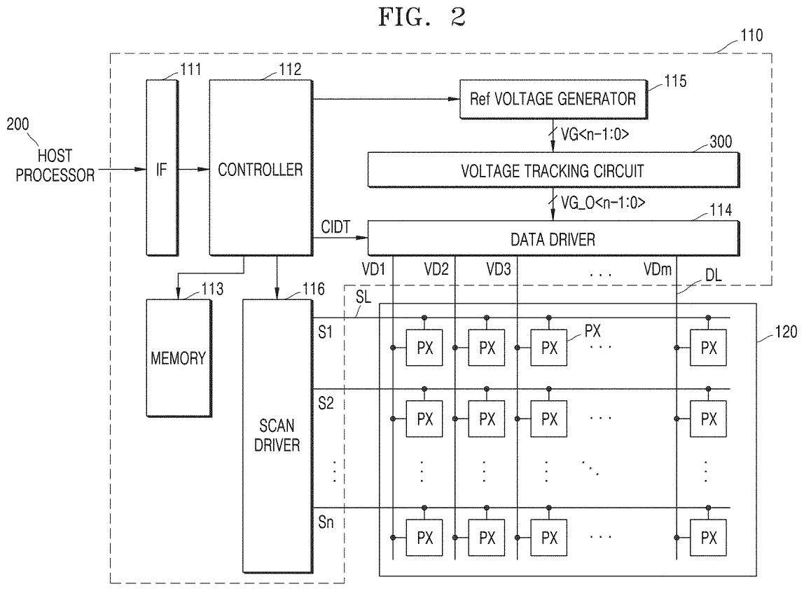

The display driving circuit 110 may include a reference voltage generator (115 of FIG. 2), which converts a pixel value into a reference voltage (or a grayscale voltage) corresponding to a gray level represented by the pixel value, and may apply the reference voltage, which corresponds to the pixel value, to a pixel of the display panel 120. Therefore, the pixel may output a light signal based on luminance corresponding to the pixel value. The reference voltage generator may generate a plurality of reference voltages.

The display driving circuit 110 according to the above example embodiment may decrease noise such as crosstalk by using the push-pull circuit and the voltage selection circuit for precharging the reference voltage in a process of supplying the reference voltage to the display panel 120.

FIG. 2 is a block diagram illustrating a display driving circuit 110 and a display panel, according to an example embodiment.

Referring to FIG. 2, the display driving circuit 110 may include an interface circuit 111, a controller 112, a memory 113, a data driver 114 (or referred to as a source driver), a reference voltage generator 115, a scan driver 116 (or referred to as a gate driver), and a voltage tracking circuit 300. The display driving circuit 110 may further include other general-use elements (for example, a voltage generator and a clock generator).

In an example embodiment, the interface circuit 111, the controller 112, the memory 113, the data driver 114, the reference voltage generator 115, the scan driver 116, and the voltage tracking circuit 300 may be integrated into one semiconductor chip. In some example embodiments, the interface circuit 111, the controller 112, the memory 113, the data driver 114, the reference voltage generator 115, and the voltage tracking circuit 300 may be provided in one semiconductor chip, and the scan driver 116 may be provided in a display panel (120 of FIG. 1).

The interface circuit 111 may transfer or receive signals or data to or from a host processor 200. The interface circuit 111 may be implemented as one of serial interfaces such as a mobile industry processor interface (MIPI) (MIPI®), a mobile display digital interface (MDDI), a display port, and an embedded display port (eDP).

The memory 113 may store, by frame units, image data received from the host processor 200. The memory 113 may be referred to as graphics random access memory (RAM) or a frame buffer. The memory 113 may include a volatile memory (e.g., dynamic random access memory (DRAM) or static random access memory (SRAM)), or a non-volatile memory (e.g., read only memory (ROM), flash memory, resistive random access memory (ReRAM), or magnetic random access memory (MRAM)). The image data received from the host processor 200 may be stored in the memory 113 before or after the controller 112 performs image processing on the image data. In an example embodiment, the display driving circuit 110 may not include the memory 113, and in this case, after the controller 112 performs image processing on the image data, the image data received from the host processor 200 may be transferred to the data driver 114.

The controller 112 may control an overall operation of the display driving circuit 110 and may control the elements (for example, the interface circuit 111, the memory 113, the data driver 114, the reference voltage generator 115, the scan driver 116, and the voltage tracking circuit 300) of the display driving circuit 110 so that the image data received from a host 100 is displayed by the display panel 120.

Also, the controller 112 may perform image processing for luminance change, size change, and format change on the received image data, or may generate new image data which is to be displayed by the display panel 120, on the basis of the received image data. To this end, the controller 112 may include a plurality of intellectual properties (IPs) for image processing.

The reference voltage generator 115 may generate a plurality of reference voltages (VG<n-1:0>) (referred to as a grayscale voltage or a gamma voltage) (where n is an integer of 2 or more) on the basis of a desired (or alternatively, predetermined) gamma curve and may provide the reference voltages (VG<n-1:0>) to the voltage tracking circuit 300. The reference voltage generator 115 may adjust a highest reference voltage and/or a lowest reference voltage on the basis of a gamma setting value and may adjust the gamma curve. In this case, the gamma curve may be a graph of luminance of a light signal output from a pixel PX of the display panel 120 with respect to a plurality of gray levels. Voltage levels of the plurality of reference voltages (VG<n-1:0>) may be adjusted so that a light signal corresponding to luminance based on the desired (or alternatively, predetermined) gamma curve, or the gamma curve may be adjusted by adjusting voltage levels of the plurality of reference voltages (VG<n-1:0>).

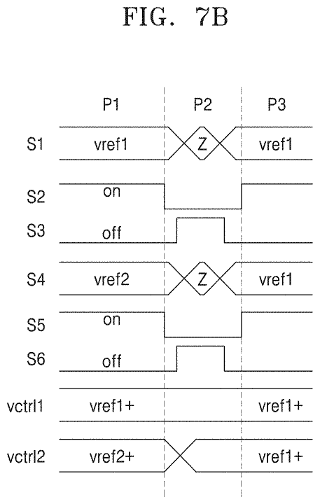

The voltage tracking circuit 300 may include a voltage selection circuit 310 and a precharging circuit 320 having a push-pull circuit structure. The voltage tracking circuit 300 may perform a precharging operation in a transition period where reference voltages supplied to a plurality of lines vary based on the plurality of reference voltages (VG<n-1:0>) and may provide the data driver 114 with a plurality of reference voltages (VG_O<n-1:0>), thereby reducing crosstalk. The transition period may be referred to as a time period between a first point in time at which a first reference voltage is applied to the input node and a second point in time at which a second reference voltage is applied to the input node. A precharging operation will be described in detail with reference to FIGS. 7A and 7B.

The voltage tracking circuit 300 may be implemented with hardware or a combination of software (or firmware) and hardware. For example, the voltage tracking circuit 300 may be implemented with a hardware logic, implemented with various hardware logics such as application specific IC (ASIC), field programmable gate array (FPGA), or complex programmable logic device (CPLD), or implemented with firmware, software, or a combination of hardware and software, which is driven in a processor such as a micro controller unit (MCU) or a CPU.

The data driver 114 may convert compensated image data CIDT, received from the controller 112, into a plurality of image signals (for example, a plurality of data voltages VD1 to VDm (where m is an integer of 2 or more) and may output the plurality of data voltages VD1 to VDm to the display panel 120 through a plurality of data lines DL.

The data driver 114 may receive the compensated image data CIDT by line data units (for example, by data units corresponding to a plurality of pixels included in one horizontal line of the display panel 120). The data driver 114 may convert line data received from the controller 112 into the plurality of data voltages VD1 to VDm on the basis of the plurality of reference voltages (VG_O<n-1:0>) received from the voltage tracking circuit 300.

The scan driver 116 may be connected to a plurality of scan lines SL of the display panel 120 and may sequentially drive the plurality of scan lines SL of the display panel 120. The scan driver 116 may sequentially provide the plurality of scan lines SL with a plurality of scan signals S1 to Sn (where n is a positive integer of 2 or more) having an active level (for example, a logic high level) on the basis of control by the controller 112. Therefore, the plurality of scan lines SL may be sequentially selected, and a plurality of data voltages VD1 to VDm may be applied to a plurality of pixels PX connected to the selected scan line SL.

The display panel 120 may include the plurality of data lines DL, the plurality of scan lines SL, and a plurality of pixels PX disposed between the lines (at intersections of the plurality of data lines DL and the plurality of scan lines SL). Each of the plurality of pixels PX may be connected to a corresponding scan line SL and a corresponding data line DL.

Each of the plurality of pixels PX may output light having a desired (or alternatively, predetermined) color and may be disposed adjacent to the same or adjacent line. Also, two or more pixels PX (for example, a red (R) pixel, a blue (B) pixel, and a green (G) pixel) for outputting pieces of light of different colors may configure one unit pixel. In this case, two or more pixels PX configuring a unit pixel may be referred to as subpixels. The display panel 120 may have an RGB structure where a red pixel, a blue pixel, and a green pixel configure one unit pixel. However, the inventive concepts are not limited thereto, and the display panel 120 may have an RGBW structure where a unit pixel further includes a white (W) pixel for enhancing luminance In some example embodiments, a unit pixel of the display panel 120 may be configured by a combination of pixels of different colors other than a red pixel, a blue pixel, and a green pixel.

The display panel 120 may include an OLED display panel where each of the plurality of pixels PX includes an OLED. However, the inventive concepts are not limited thereto, and the display panel 120 may be implemented as a different kind of flat display panel or flexible display panel.

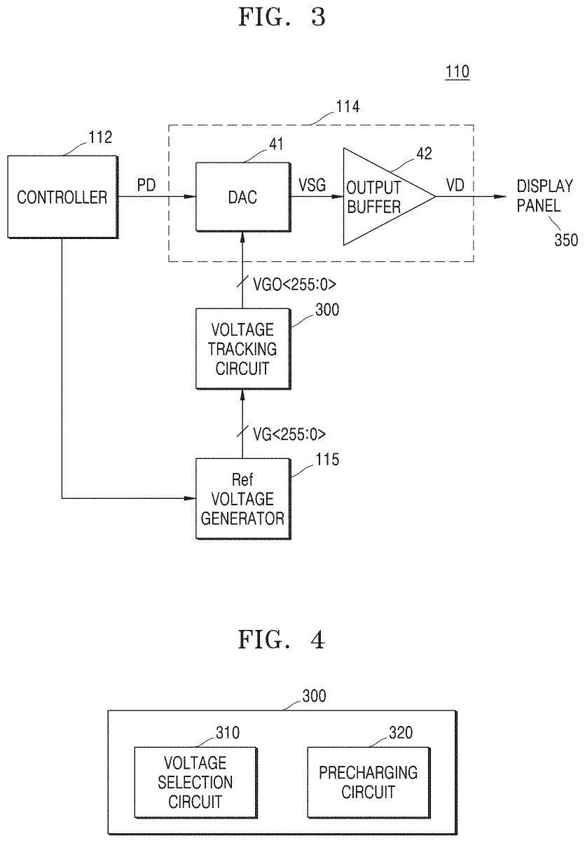

FIG. 3 is a block diagram schematically illustrating a display driving circuit 110 according to an example embodiment.

Referring to FIG. 3, the display driving circuit 110 may include a controller 112, a data driver 114, a display panel 350, a reference voltage generator 115, and a voltage tracking circuit 300.

The reference voltage generator 115 may generate a plurality of reference voltages (VG<n-1:0>) (where n is an integer of 2 or more) on the basis of a desired (or alternatively, predetermined) gamma curve and may provide the reference voltages (VG<n-1:0>) to the voltage tracking circuit 300.

The voltage tracking circuit 300 may perform a precharging operation in a transition period where reference voltages vary, in order to decrease crosstalk in a process of providing the reference voltages (VG<n-1:0>).

The controller 112 may perform a preprocessing process on input pixel data to generate pixel data PD (e.g., CIDT) and may provide the pixel data PD to the data driver 114.

The data driver 114 may include a digital-to-analog converter (DAC) 41 and an output buffer 42. In FIG. 3, it is illustrated that the data driver 114 includes a driving circuit of one channel including the DAC 41 and the output buffer 42, but this is for convenience of description and the data driver 114 may include driving circuits of a plurality of channels.

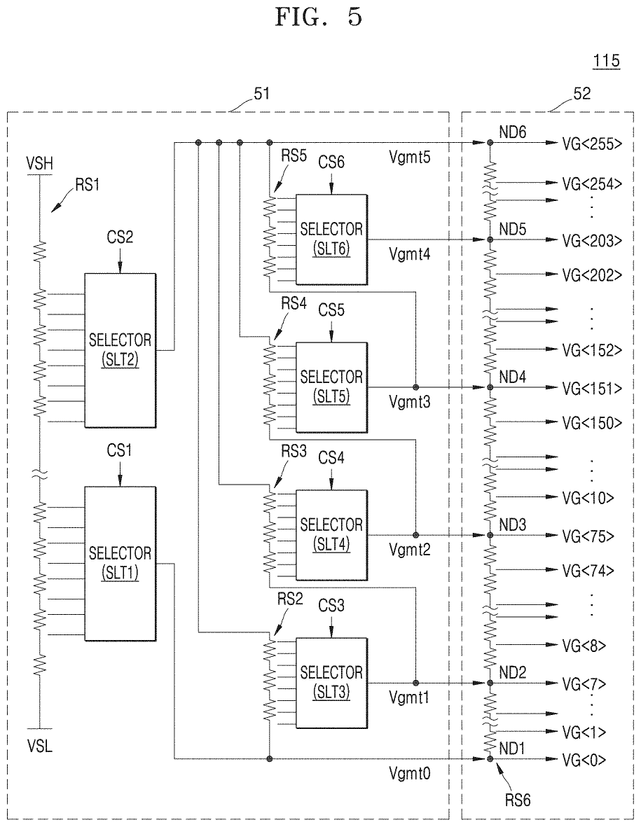

FIG. 4 is a block diagram schematically illustrating a voltage tracking circuit 300 according to an example embodiment.

The voltage tracking circuit 300 may include a voltage selection circuit 310 and a precharging circuit 320. The voltage selection circuit 310 may generate a control signal for a precharging operation performed on an input node of an output buffer (e.g., a first output buffer CH1 and a second output buffer CH2 in FIG. 7A) in a transition period where a reference voltage applied to the output buffer varies. The voltage selection circuit 310 may generate a control voltage which is very close to a target reference voltage and may precharge the input node, thereby further enhancing performance associated with crosstalk.

The precharging circuit 320 may precharge the input node with the target reference voltage which is to be supplied to an output node through a push-pull circuit structure and may limit the precharge to a certain range. A push-pull circuit may stop an operation when a gate-source voltage thereof is less than a threshold voltage. For example, when a higher voltage level than a sum of a first control signal and the threshold voltage is supplied to a first node of the precharging circuit 320, a second transistor may be turned on. When a lower voltage level than a difference between the first control signal and the threshold voltage is supplied to the first node of the precharging circuit 320, a first transistor may be turned on. Therefore, the precharging circuit 320 may limit a voltage of the first node to a range from the difference between the first control signal and the threshold voltage to the sum of the first control signal and the threshold voltage. In this case, the first transistor may include an NMOS transistor, and the second transistor may include a PMOS transistor.

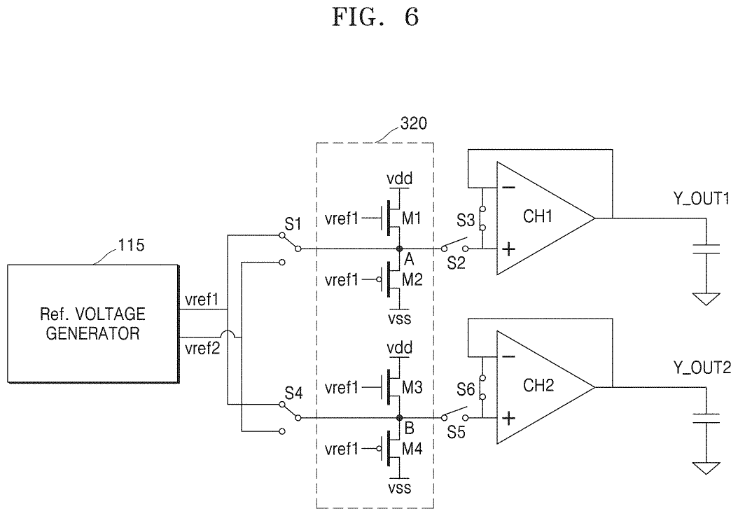

FIG. 5 is a circuit diagram illustrating a reference voltage generator 115 according to an example embodiment.

It may be assumed that the reference voltage generator 115 generates 256 reference voltages GV<255:0>.

Referring to FIG. 5, the reference voltage generator 115 may include a gamma tap voltage generating unit 51 and a reference voltage output unit 52. The gamma tap voltage generating unit 51 may generate a plurality of gamma tap voltages Vgmt0 to Vgmt5 corresponding to a plurality of gamma taps for determining a gamma curve and may generate a plurality of reference voltages (for example, zeroth to 255^{th} reference voltages) VG<0> to VG<255> corresponding to a plurality of gray levels on the basis of the plurality of gamma tap voltages Vgmt0 to Vgmt5. In this case, the plurality of gamma taps may denote a certain gray level (for example, a plurality of reference gray levels) for determining the gamma curve among the plurality of gray levels, and the plurality of gamma tap voltages Vgmt0 to Vgmt5 may correspond to some of the plurality of reference voltages (for example, the zeroth to 255^{th} reference voltages) VG<0> to VG<255>.

The gamma tap voltage generating unit 51 may include a plurality of resistor strings RS1 to RS5 and a plurality of selectors SLT1 to SLT6. The number of resistor strings and the number of selectors may vary. Although not shown, the gamma tap voltage generating unit 51 may further include a plurality of buffers (not shown) (e.g., a current buffer) for stably maintaining voltage levels of the plurality of gamma tap voltages Vgmt0 to Vgmt5 output from the plurality of selectors (e.g., first to sixth selectors) SLT1 to SLT6.

Each of the plurality of resistor strings (e.g., first to fifth resistor strings) RS1 to RS5 may voltage-divide voltages applied to both ends thereof by using resistors included therein to generate a plurality of voltages and may output the plurality of voltages. Each of the plurality of selectors SLT1 to SLT6 may select one voltage from among voltages output from a resistor string on the basis of a corresponding selection signal of a plurality of selection signals (e.g., first to sixth selection signals CS1 to CS6) and may output the selected voltage. Therefore, the plurality of gamma tap voltages (e.g., zeroth to fifth gamma tap voltages) Vgmt0 to Vgmt5 may be generated.

For example, the first resistor string RS1 may voltage-divide a reference high voltage VSH and a reference low voltage VSL to generate a plurality of voltages, and in response to the first selection signal CS1, the first selector SLT1 may select one voltage from among the plurality of voltages received from the first resistor string RS1 and may output the selected voltage as the zeroth gamma tap voltage Vgmt0. The zeroth gamma tap voltage Vgmt0 may be a lowest reference voltage (e.g., the zeroth reference gamma voltage VG<0>). In response to the second selection signal CS2, the second selector SLT2 may select one voltage from among the plurality of voltages received from the first resistor string RS1 and may output the selected voltage as the fifth gamma tap voltage Vgmt5. The fifth gamma tap voltage Vgmt5 may be a highest reference voltage (e.g., the zeroth reference gamma voltage VG<0>).

Third to sixth resistor strings RS3 to RS6 may voltage-divide the fifth gamma tap voltage Vgmt5 and a different gamma tap voltage (e.g., one of the zeroth to fourth gamma tap voltages Vgmt0 to Vgmt4) by using resistors included therein, select one voltage from among a plurality of voltages generated based on the voltage division in response to a corresponding selection signal (e.g., third to sixth selection signals CS3 to CS6), and output the selected voltage as each of the first to fourth gamma tap voltages Vgmt1 to Vgmt4. Each of the first to fourth gamma tap voltages Vgmt1 to Vgmt4 may be one of intermediate reference voltages. For example, the first gamma tap voltage Vgmt1 may be output as the seventh reference voltage VG<7>, the second gamma tap voltage Vgmt2 may be output as the 75^{th} reference voltage VG<75>, the third gamma tap voltage Vgmt3 may be output as the 151^{st} reference voltage VG<151>, and the fourth gamma tap voltage Vgmt4 may be output as the 203^{rd} reference voltage VG<203>.

Therefore, the gamma tap voltage generating unit 51 may generate the plurality of gamma tap voltages Vgmt0 to Vgmt5 corresponding to the plurality of gamma taps (e.g., the plurality of reference gray levels). At this time, the first to sixth selection signals CS1 to CS6 may vary, and a voltage level of each of the plurality of gamma tap voltages Vgmt0 to Vgmt5 may be adjusted. Therefore, a highest reference voltage and a lowest reference voltage may be adjusted based on the first selection signal CS1 and the second selection signal CS2, and the plurality of intermediate reference voltages for determining the gamma curve may be adjusted based on the third to sixth selection signals CS3 to CS6.

The reference voltage output unit 52 may include a resistor string (for example, the sixth resistor string) RS6 to which the plurality of gamma tap voltages (e.g., the zeroth to fifth gamma tap voltages) Vgmt0 to Vgmt5. The sixth resistor string RS6 may voltage-divide the plurality of gamma tap voltages (e.g., the zeroth to fifth gamma tap voltages) Vgmt0 to Vgmt5 applied to a plurality of nodes ND1 to ND6, respectively, to generate the plurality of reference voltages (e.g., zeroth to 255^{th} reference voltages) VG<0> to VG<255>.

In this case, resistance values of resistors provided between two adjacent nodes among the plurality of nodes ND1 to ND6 may be the same, or all resistance values of resistors included in the sixth resistor string RS6 may be the same. Therefore, a voltage difference between reference voltages between two adjacent gamma tap voltages may be the same. For example, a voltage difference between a pair of adjacent reference voltages among the zeroth to seventh reference voltages VG<0> to VG<7> may be the same as a voltage difference between a pair of adjacent reference voltages. Further, a voltage difference between a pair of adjacent reference voltages among the seventh to 75^{th} reference voltages VG<7> to VG<75> may be the same as a voltage difference between a pair of adjacent reference voltages. As described above, the amount of increased voltage between reference voltages may be the same between adjacent gamma tap voltages.

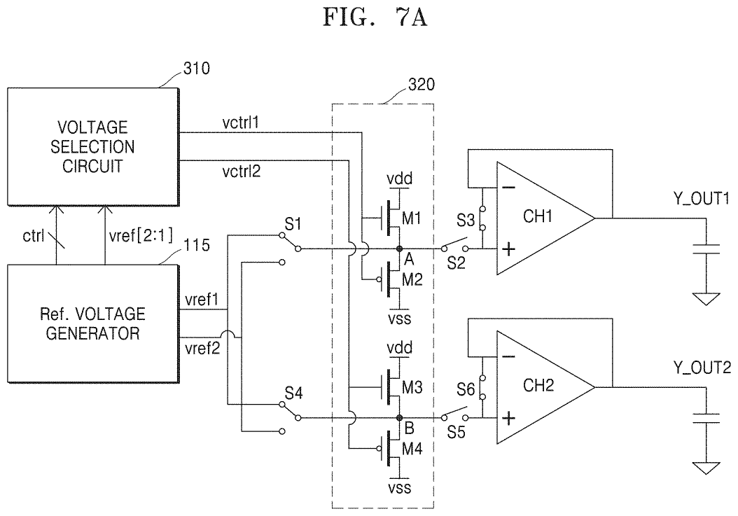

FIG. 6 is a block diagram schematically illustrating a voltage tracking circuit according to an example embodiment.

Referring to FIGS. 2 and 6, a reference voltage generator 115 may generate a plurality of reference voltages (VG<n-1:0) (e.g., n number of reference voltages, where n is an integer of 2 or more) and may provide the reference voltages (VG<n-1:0>) to the voltage tracking circuit 300. The generated plurality of reference voltages may be provided to a plurality of channels (e.g., a plurality of output buffers).

For convenience of description, it may be assumed that the reference voltage generator 115 generates two reference voltages (e.g., a first reference voltage vref1 and a second reference voltage vref2) and provides two channels (e.g., a first output buffer CH1 and a second output buffer CH2) included in a display panel.

For example, referring to FIG. 6, the reference voltage generator 115 may supply the first reference voltage vref1 and the second reference voltage vref2 to the first output buffer CH1 and the second output buffer CH2 each included in the display panel. A first switch S1 may select a reference voltage which is to be supplied to the first output buffer CH1, and a fourth switch S4 may select a reference voltage which is to be supplied to the second output buffer CH2.

A precharging circuit 320 may include a first push-pull structure connected to a first node A and a second push-pull structure connected to a second node B.

The first push-pull structure may include a first transistor M1, which performs a pull-up operation, and a second transistor M2, which performs a pull-down operation. The first reference voltage vref1 or the second reference voltage vref2 may be applied to a gate terminal of each of the first transistor M1 and the second transistor M2. The precharging circuit 320 may perform precharging on the first node A connected to a source terminal of each of the first transistor M1 and the second transistor M2. The first output buffer CH1 may generate an output voltage Y_OUT1 supplied to the display panel on the basis of a reference voltage supplied to the first node A.

The second push-pull structure may include a third transistor M3, which performs the pull-up operation, and a fourth transistor M4, which performs the pull-down operation. The first reference voltage vref1 or the second reference voltage vref2 may be applied to a gate terminal of each of the third transistor M3 and the fourth transistor M4. The precharging circuit 320 may perform precharging on the first node B connected to a source terminal of each of the third transistor M3 and the fourth transistor M4. The second output buffer CH2 may generate an output voltage Y_OUT2 supplied to the display panel on the basis of a reference voltage supplied to the second node B.

The precharging circuit 320 may precharge the first node A or the second node B with a target reference voltage which is to be supplied to an output node through the push-pull circuit structure. A push-pull circuit may stop an operation when a gate-source voltage thereof is less than a threshold voltage. For example, when a voltage level, which is higher than a sum of the first reference voltage vref1 and a threshold voltage vth2 of the second transistor M2, is supplied to the first node A, the second transistor M2 may be turned on. When a voltage level, which is lower than a difference between the first reference voltage vref1 and a threshold voltage vth1 of the first transistor M1, is supplied to the first node A, the first transistor M1 may be turned on. In the following description, it may be assumed that the threshold voltage vth1 of the first transistor M1 is the same as the threshold voltage vth2 of the second transistor M2, but example embodiments are not limited thereto. Therefore, the precharging circuit 320 may limit a voltage of the first node A to a range from a difference between the first reference voltage vref1 and a threshold voltage to a sum of the first reference voltage vref1 and the threshold voltage.

When a voltage level, which is higher than the sum of the first reference voltage vref1 and the threshold voltage, is supplied to the second node B, the fourth transistor M4 may be turned on. When a voltage level, which is lower than the difference between the first reference voltage vref1 and the threshold voltage, is supplied to the second node B, the third transistor M3 may be turned on. Therefore, the precharging circuit 320 may limit a voltage of the second node B to a range from the difference between the first reference voltage vref1 and the threshold voltage to the sum of the first reference voltage vref1 and the threshold voltage.

FIG. 7A is a circuit diagram illustrating a voltage tracking circuit according to an example embodiment, and FIG. 7B is a graph for describing an operation signal of FIG. 7A.

Referring to FIGS. 2 and 7A, a reference voltage generator 115 may generate a plurality of reference voltages (VG<n-1:0) (e.g., n number of reference voltage, where n is an integer of 2 or more) and may provide the reference voltages (VG<n-1:0>) to a plurality of channels through a plurality of output buffers.

For convenience of description, it may be assumed that the reference voltage generator 115 generates two reference voltages (e.g., a first reference voltage vref1 and a second reference voltage vref2) and provides the first reference voltage vref1 and the second reference voltage vref2 to two channels (e.g., a first output buffer CH1 and a second output buffer CH2) included in a display panel.

For example, referring to FIG. 7A, the reference voltage generator 115 may supply the first reference voltage vref1 and the second reference voltage vref2 to the first output buffer CH1 and the second output buffer CH2 each included in the display panel. A first switch S1 may select a reference voltage which is to be supplied to the first output buffer CH1, and a fourth switch S4 may select a reference voltage which is to be supplied to the second output buffer CH2. The reference voltage generator 115 may supply a voltage selection circuit 310 with a reference voltage vref[2:1] and a control signal ctrl each generated for a precharging operation.

The voltage selection circuit 310 may generate a first control signal vctrl1 for the precharging operation before the reference voltage is supplied to the first output buffer CH1, on the basis of the reference voltage vref[2:1] and the control signal ctrl each received thereby. A precharging circuit 320 may apply the first control signal vctrl1 to a gate terminal of each of a first transistor M1 and a second transistor M2. The precharging circuit 320 may perform precharging on a first node A connected to a source terminal of each of the first transistor M1 and the second transistor M2. The first output buffer CH1 may generate an output voltage Y_OUT1 supplied to the display panel on the basis of the reference voltage supplied to the first node A.

The voltage selection circuit 310 may generate a second control signal vctrl2 for the precharging operation before the reference voltage is supplied to the second output buffer CH2, on the basis of the reference voltage vref[2:1] and the control signal ctrl each received thereby. The precharging circuit 320 may apply the second control signal vctrl2 to a gate terminal of each of a third transistor M3 and a fourth transistor M4. The precharging circuit 320 may perform precharging on a second node B connected to a source terminal of each of the third transistor M3 and the fourth transistor M4. The second output buffer CH2 may generate an output voltage Y_OUT2 supplied to the display panel on the basis of the reference voltage supplied to the second node B.

The voltage selection circuit 310 may generate a control voltage which is very close to a target reference voltage and may apply the control voltage to perform a precharging operation, thereby further enhancing performance associated with crosstalk. The precharging circuit 320 may precharge the input node of the output buffer (e.g., a first output buffer CH1 and a second output buffer CH2 in FIG. 7A) with the target reference voltage which is to be supplied to an output node through a push-pull circuit structure and may limit the precharge to a certain range. A push-pull circuit may stop an operation when a gate-source voltage thereof is less than a threshold voltage. For example, when a higher voltage level than a sum of the first control signal vctrl1 and a threshold voltage is supplied to the first node A of the precharging circuit 320, the second transistor M2 may be turned on. When a lower voltage level than a difference between the first control signal vctrl1 and the threshold voltage is supplied to the first node A of the precharging circuit 320, the first transistor M1 may be turned on. Therefore, the precharging circuit 320 may limit a voltage of the first node A to a range from the difference between the first control signal vctrl1 and the threshold voltage to the sum of the first control signal vctrl1 and the threshold voltage.

When a higher voltage level than a sum of the second control signal vctrl2 and the threshold voltage is supplied to the second node B of the precharging circuit 320, the fourth transistor M4 may be turned on. When a lower voltage level than a difference between the second control signal vctrl2 and the threshold voltage is supplied to the second node B of the precharging circuit 320, the third transistor M3 may be turned on. Therefore, the precharging circuit 320 may limit a voltage of the second node B to a range from the difference between the second control signal vctrl2 and the threshold voltage to the sum of the second control signal vctrl2 and the threshold voltage.

FIG. 7B describes a signal applied to a switch and a control signal when the same reference voltage is supplied to a first output buffer CH1 and a varied reference voltage is applied to a second output buffer CH2.

The display driving circuit 110 may connect the first switch S1 to the first reference voltage vref1 so as to supply the first reference voltage vref1 to the first node A in a first period P1. At this time, the display driving circuit 110 may maintain the second switch S2 in a turn-on state and may maintain the third switch S3 in a turn-off state. The voltage selection circuit 310 may generate the first control signal vctrl1 on the basis of the first reference voltage vref1 and may provide the first control signal vctrl1 to the precharging circuit 320, in order to precharge the first node A.

The display driving circuit 110 may connect the fourth switch S4 to the first reference voltage vref1 so as to supply the first reference voltage vref1 to the second node B in the first period P1. At this time, the display driving circuit 110 may maintain a fifth switch S5 in a turn-on state and may maintain a sixth switch S6 in a turn-off state. The voltage selection circuit 310 may generate the second control signal vctrl2 on the basis of the second reference voltage vref2 and may provide the second control signal vctrl2 to the precharging circuit 320, in order to precharge the second node B.

The display driving circuit 110 may change the first node A and the second B to a high impedance (High-Z) state where a connection to the first output buffer CH1 and the second output buffer CH2 is blocked, in a second period P2, which is a transition period for varying a reference voltage. That is, when all of the second switch S2 and the fifth switch S5 are turned off, the first switch S1 and the fourth switch S4 may be floated and may be changed to the high impedance (High-Z) state. The display driving circuit 110 may change the first switch S1 and the fourth switch S4 to the high impedance state or a floating state in the second period P2.

The display driving circuit 110 may change the second switch S2 to the turn-off state and may change the third switch S3 to the turn-on state. The display driving circuit 110 may identically maintain the first control signal vctrl1 generated based on the first reference voltage vref1 in the second period P2.

The display driving circuit 110 may change the fifth switch S5 to the turn-off state and may change the sixth switch S6 to the turn-on state. The display driving circuit 110 may change the second control signal vctrl2 generated based on the first reference voltage vref1 to a signal generated based on the second reference voltage vref2 in the second period P2. In this case, even when noise occurs due to the second control signal vctrl2 being changed in the display driving circuit 110, the first switch S1, the second switch S2, the fourth switch S4, and the fifth switch S5 may be in a disconnected state, and thus, the noise may not adversely affect other channels, thereby decreasing crosstalk.

Therefore, the display driving circuit 110 may provide a varied reference voltage to the display panel in a third period P3 without noise.

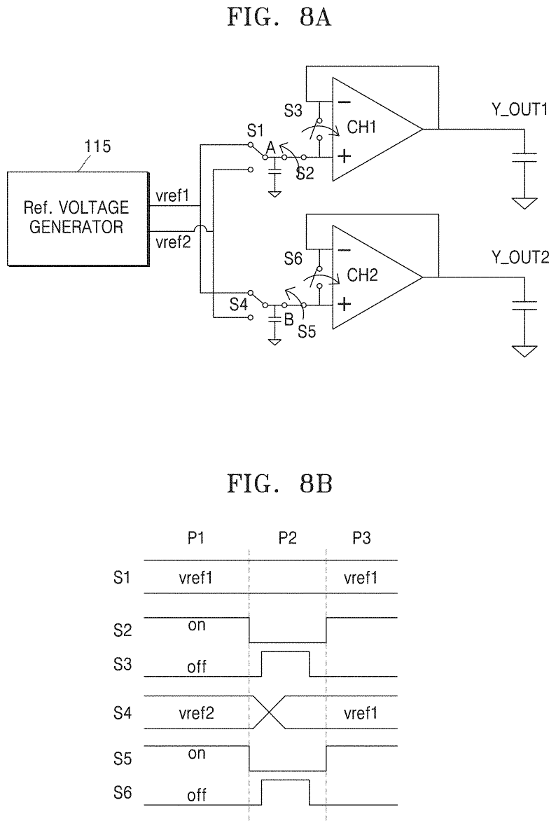

FIG. 8A is a circuit diagram illustrating a reference voltage generator 115 and a buffer circuit according to an example embodiment, and FIG. 8B is a graph for describing an operation signal of FIG. 8A.

Referring to FIGS. 2 and 8A, the reference voltage generator 115 may generate a plurality of reference voltages (VG<n-1:0) (e.g., n number of reference voltages, where n is an integer of 2 or more) and may provide the reference voltages (VG<n-1:0>). The generated plurality of reference voltages (VG<n-1:0) may be provided to the buffer circuit including a plurality of channels CH1 and CH2.

For convenience of description, it may be assumed that the reference voltage generator 115 generates two reference voltages (e.g., a first reference voltage vref1 and a second reference voltage vref2) and provides the first reference voltage vref1 and the second reference voltage vref2 to two channels (e.g., a first output buffer CH1 and a second output buffer CH2) included in a display panel.

For example, referring to FIG. 8A, the display driving circuit 110 may supply the first reference voltage vref1 and the second reference voltage vref2, generated by the reference voltage generator 115, to the first output buffer CH1 and the second output buffer CH2 each included in the display panel. The display driving circuit 110 may select a reference voltage which is to be supplied to the first output buffer CH1 through a first switch Si and may select a reference voltage which is to be supplied to the second output buffer CH2 through a fourth switch S4.

FIG. 8B describes a signal applied to a switch and a control signal when the same reference voltage is supplied to a first output buffer CH1 and a varied reference voltage is applied to a second output buffer CH2.

The display driving circuit 110 may connect the first switch Si to the first reference voltage vref1 so as to supply the first reference voltage vref1 to a first node A in a first period P1. At this time, the display driving circuit 110 may maintain a second switch S2 in a turn-on state and may maintain a third switch S3 in a turn-off state.

The display driving circuit 110 may connect the fourth switch S4 to the second reference voltage vref2 so as to supply the second reference voltage vref2 to a second node B in the first period P1. At this time, the display driving circuit 110 may maintain a fifth switch S5 in the turn-on state and may maintain a sixth switch S6 in the turn-off state.

The display driving circuit 110 may maintain the first switch Si in a current state and may change the fourth switch S4 from the second reference voltage vref2 to the first reference voltage vref1, in a second period P2, which is a transition period for varying a reference voltage.

The display driving circuit 110 may change the second switch S2 to the turn-off state and may change the third switch S3 to the turn-on state, in the second period P2. The display driving circuit 110 may change the fifth switch S5 to the turn-off state and may change the sixth switch S6 to the turn-on state, in the second period P2.

At this time, when noise occurs in the second node B due to the fourth switch S4 being changed in the display driving circuit 110, the first switch S1 may be connected to the fourth switch S4, and due to this, the noise may adversely affect the first node A, causing crosstalk. Therefore, the display driving circuit 110 may provide the display panel with a reference voltage where noise occurs in a third period P3.

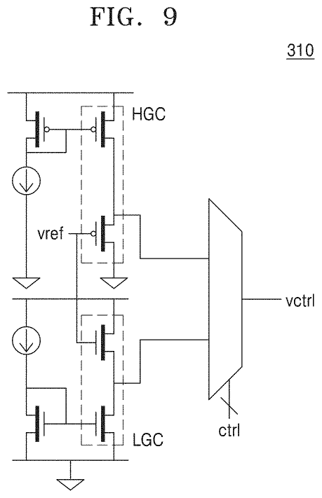

FIG. 9 is a circuit diagram illustrating a voltage selection circuit 310 according to an example embodiment.

The voltage selection circuit 310 may generate a control signal for a precharging operation before a reference voltage is supplied to an output buffer, on the basis of a reference voltage vref and a control signal ctrl each received thereby. The voltage selection circuit 310 may generate a control voltage which is very close to a target reference voltage and may apply the control voltage to a precharging operation, thereby further enhancing performance associated with crosstalk.

For example, when the received reference voltage vref is changed from a high voltage level to a low voltage level, the voltage selection circuit 310 may select a high gray code circuit HGC by using a multiplexer, and when the received reference voltage vref is changed from a low voltage level to a high voltage level, the voltage selection circuit 310 may select a low gray code circuit LGC.

When the received reference voltage vref is changed from a high voltage level to a low voltage level, the voltage selection circuit 310 may output a control signal vctrl higher than the received reference voltage vref by a threshold voltage level. When the received reference voltage vref is changed from a low voltage level to a high voltage level, the voltage selection circuit 310 may output the control signal vctrl lower than the received reference voltage vref by a threshold voltage level. Therefore, the voltage selection circuit 310 may output the control signal vctrl within a threshold voltage range on the basis of a target reference voltage vref to precharge a voltage node.

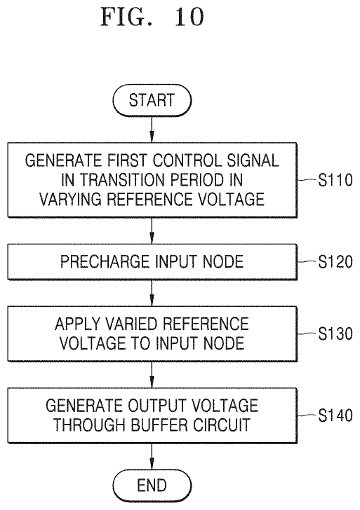

FIG. 10 is a flowchart illustrating an operating method of the display driving circuit 110 according to an example embodiment.

Referring to FIGS. 2, 7A, and 10, in operation S110, the display driving circuit 110 may generate a first control signal for precharging an input node of a buffer circuit (e.g., a first output buffer CH1 and/or a second output buffer CH2 in FIG. 7A) in a transition period before a second reference voltage is applied to the input node to which a first reference voltage has been applied. The display driving circuit 110 may further include the voltage selection circuit 310, which generates the first control signal corresponding to a reference voltage. When the first reference voltage is higher than the second reference voltage, the voltage selection circuit 310 may generate the first control signal by adding a desired (or alternatively, predetermined) threshold voltage to the second reference voltage, and when the first reference voltage is lower than the second reference voltage, the voltage selection circuit 310 may generate the first control signal by subtracting the desired (or alternatively, predetermined) threshold voltage from the second reference voltage. In this case, the second reference voltage may differ from the first reference voltage.

The precharging circuit 320 included in the display driving circuit 110 may precharge the input node on the basis of the first control signal in operation S120. The display driving circuit 110 may further include a switch circuit configured to provide the input node with one of a plurality of reference voltages on the basis of a second control signal. A controller may generate the second control signal so that the input node is floated in a transition period.

The precharging circuit 320 may apply the first control signal to a gate terminal of each of a first NMOS transistor and a first PMOS transistor to precharge the input node through a source terminal of the first NMOS transistor and a source terminal of the first PMOS transistor. The precharging circuit 320 may precharge the input node within a desired (or alternatively, predetermined) range of the second reference voltage.

The display driving circuit 110 may use a signal, generated by the voltage selection circuit 310, as the first control signal or the second control signal, and may use the reference voltage, generated by the reference voltage generator 115, as the first control signal or the second control signal.

The display driving circuit 110 may apply the second reference voltage to the input node in operation S130. The input node may be in a state that is precharged based on the first control signal, and thus, a difference with the second reference voltage may be less than or equal to a threshold voltage, thereby improving performance associated with noise because a variation of a voltage is not large.

The display driving circuit 110 may generate an output voltage on the basis of the second reference voltage in operation S140. The display driving circuit 110 may include a data driver which receives the plurality of reference voltages from the reference voltage generator 115 and outputs a data voltage, corresponding to a reference voltage selected from among the plurality of reference voltages by the controller, to the display panel.

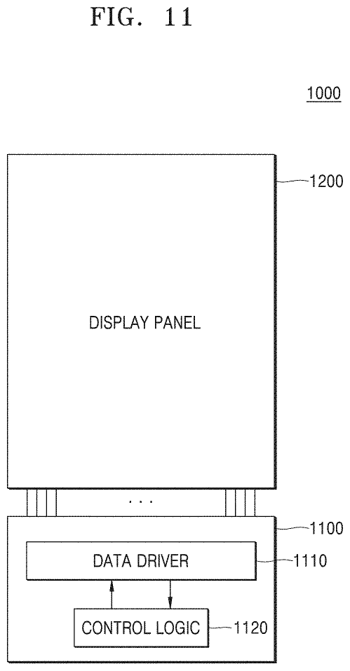

FIG. 11 illustrates an implementation example of a display apparatus 1000 according to an example embodiment. The display apparatus 1000 of FIG. 1 may be an apparatus including a small display panel 1200, and for example, may be applied to mobile devices such as smartphones and tablet personal computers (PCs).

Referring to FIG. 11, the display apparatus 1000 may include a display driving circuit 1100 and a display panel 1200. The display driving circuit 1100 may be configured with one or more ICs and may be mounted on a circuit film such as a tape carrier package (TCP), a chip on film (COF), or a flexible printed circuit (FPC), attached on the display panel 1200 in a tape automatic bonding (TAB) type, or equipped in a non-display area (e.g., an area which does not display an image) of the display panel 1200 in a chip on glass (COG) type.

The display driving circuit 1100 may include a data driver 1110 and a control logic 1120, and moreover, may further include a gate driver. In an example embodiment, the gate driver may be equipped in the display panel 1200.

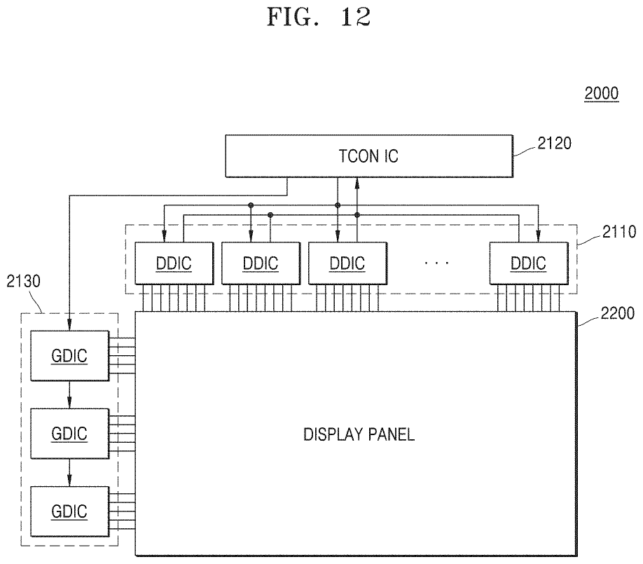

FIG. 12 illustrates an implementation example of a display apparatus 2000 according to an example embodiment. The display apparatus 2000 of FIG. 12 may be an apparatus including a medium-large display panel 2200, and for example, may be applied to televisions (TVs), monitors, etc.

Referring to FIG. 12, the display apparatus 2000 may include a data driver 2110, a timing controller 2120, a gate driver 2130, and a display panel 2200.

The timing controller 2120 may be configured with one or more ICs or modules. The timing controller 2120 may communicate with a plurality of data driving ICs DDIC and a plurality of gate driving ICs GDIC through a desired (or alternatively, predetermined) interface.

The timing controller 2120 may generate control signals of controlling a driving timing of each of the plurality of data driving ICs DDIC and the plurality of gate driving ICs GDIC and may provide the control signals to the plurality of data driving ICs DDIC and the plurality of gate driving ICs GDIC.

The data driver 2110 may include the plurality of data driving ICs DDIC, and the plurality of data driving ICs DDIC may be mounted on a circuit film such as a TCP, a COF, or an FPC, attached on the display panel 2200 in the TAB type, or equipped in a non-display area of the display panel 2200 in the COG type.

The gate driver 2130 may include the plurality of gate driving ICs GDIC, and the plurality of gate driving ICs GDIC may be mounted on a circuit film, or an FPC, attached on the display panel 2200 in the TAB type, or equipped in the non-display area of the display panel 2200 in the COG type. In some example embodiments, the gate driver 2130 may be directly provided on a lower substrate of the display panel 2200 in a gate-driver in panel (GIP) type. The gate driver 2130 may be provided in a non-display area outside a pixel array where a plurality of subpixels PX are provided, in the display panel 2200 and may be formed through the same thin film transistor (TFT) process as the subpixels PX.

Any functional blocks shown in the figures and described above may be implemented in processing circuitry such as hardware including logic circuits; a hardware/software combination such as a processor executing software; or a combination thereof. For example, the processing circuitry more specifically may include, but is not limited to, a central processing unit (CPU) , an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc.

While the inventive concepts have been particularly shown and described with reference to some example embodiments thereof, it will be understood that various changes in form and details may be made therein without departing from the spirit and scope of the following claims.

What is claimed is:

1. A display driving circuit comprising:
a reference voltage generator configured to generate a plurality of reference voltages;
a buffer circuit configured to generate an output voltage based on a reference voltage, from among the reference voltages, applied to an input node thereof; and
a precharging circuit configured to precharge the input node based on a first control signal in a transition period, the transition period being a time period between a first point in time at which a first reference voltage is applied to the input node and a second point in time at which a second reference voltage is applied to the input node.

2. The display driving circuit of claim 1, further comprising:
a switch circuit configured to provide one of the plurality of reference voltages to the input node based on a second control signal, and float the input node in the transition period.

3. The display driving circuit of claim 1, wherein the second reference voltage differs from the first reference voltage.

4. The display driving circuit of claim 1, wherein the precharging circuit is configured to apply the first control signal to a gate terminal of each of a first NMOS transistor and a first PMOS transistor to precharge the input node through a source terminal of the first NMOS transistor and a source terminal of the first PMOS transistor.

5. The display driving circuit of claim 1, wherein the precharging circuit is configured to precharge the input node within a certain range of the second reference voltage.

6. The display driving circuit of claim 1, further comprising:
a voltage selection circuit configured to generate the first control signal based on the reference voltage.

7. The display driving circuit of claim 6, wherein the voltage selection circuit is further configured to,
when the first reference voltage is higher than the second reference voltage, generate the first control signal having a first voltage level obtained by adding a threshold voltage to the second reference voltage, and
when the first reference voltage is lower than the second reference voltage, generate the first control signal having a second voltage level obtained by subtracting the threshold voltage from the second reference voltage.

8. The display driving circuit of claim 1, further comprising:
a data driver configured to receive the plurality of reference voltages from the reference voltage generator, and output a data voltage corresponding to a specific reference voltage selected from among the plurality of reference voltages by a controller to a display panel.

9. An operating method of a display driving circuit, the operating method comprising:
generating a first control signal for precharging an input node in a transition period, the transition period being a time period between a first point in time at which a first reference voltage is applied to the input node and a second point in time at which a second reference voltage is applied to the input node;
precharging the input node based on the first control signal;
applying the second reference voltage to the input node; and
generating an output voltage based on the second reference voltage.

10. The operating method of claim 9, further comprising:
floating the input node through a switch circuit in the precharging,
wherein the switch circuit is configured to provide one of a plurality of reference voltages to the input node based on a second control signal.

11. The operating method of claim 9, wherein the second reference voltage differs from the first reference voltage.

12. The operating method of claim 9, wherein the precharging comprises applying the first control signal to a gate terminal of each of a first NMOS transistor and a first PMOS transistor to precharge the input node through a source terminal of the first NMOS transistor and a source terminal of the first PMOS transistor.

13. The operating method of claim 9, wherein the precharging comprises precharging the input node within a certain range of the second reference voltage.

14. The operating method of claim 9, wherein the generating a first control signal comprises:
when the first reference voltage is higher than the second reference voltage, generating the first control signal by adding a threshold voltage to the second reference voltage; and
when the first reference voltage is lower than the second reference voltage, generating the first control signal by subtracting the threshold voltage from the second reference voltage.

15. The operating method of claim 9, further comprising:
outputting a data voltage corresponding to the generated output voltage to a display panel.

16. A display apparatus comprising:
a display panel; and
a display driving circuit configured to drive the display panel so that the display panel displays an image, wherein
the display driving circuit includes,
a reference voltage generator configured to generate a plurality of reference voltages,
a buffer circuit configured to generate an output voltage from a reference voltage, from among the reference voltages, applied to an input node thereof,
a precharging circuit configured to precharge the input node based on a first control signal, and
a controller configured to generate the first control signal for precharging the input node in a transition period, the transition period being a time period between a first point in time at which a first reference voltage is applied to the input node and a second point in time at which a second reference voltage is applied to the input node.

17. The display apparatus of claim 16, further comprising:
a switch circuit configured to provide one of the plurality of reference voltages to the input node based on a second control signal,
wherein the controller is further configured to generate the second control signal for floating the input node in the transition period.

18. The display apparatus of claim 16, wherein the second reference voltage differs from the first reference voltage.

19. The display apparatus of claim 16, wherein the precharging circuit is configured to apply the first control signal to a gate terminal of each of a first NMOS transistor and a first PMOS transistor to precharge the input node within a certain range through a source terminal of the first NMOS transistor and a source terminal of the first PMOS transistor.

20. The display apparatus of claim 16, further comprising:
a voltage selection circuit configured to generate the first control signal corresponding to the reference voltage, wherein the voltage selection circuit is configured to,
when the first reference voltage is higher than the second reference voltage, generate the first control signal by adding a threshold voltage to the second reference voltage, and
when the first reference voltage is lower than the second reference voltage, generate the first control signal by subtracting the threshold voltage from the second reference voltage.
